(19) United States
(12) Patent Application Publication
(10) Pub. No.: US 2016/0239542 A1
(43) Pub. Date: Aug. 18, 2016

(54) Method, Apparatus, and System for Storing Execution Plan

(71) Applicant: Huawei Technologies Co., Ltd., Shenzhen (CN)

(72) Inventors: Wei Yu, Beijing (CN); Jijun Wen, Beijing (CN); Huijun Liu, Beijing (CN)

(21) Appl. No.: 15/136,472

(22) Filed: Apr. 22, 2016

Related U.S. Application Data
(63) Continuation of application No. PCT/CN2014/075520, filed on Apr. 16, 2014.

(30) Foreign Application Priority Data
Oct. 24, 2013 (CN) 201310507367.8

(51) Int. Cl. G06F 17/30; H04L 29/08

(52) U.S. Cl. CPC G06F 17/30463; H04L 67/2842

(57) ABSTRACT

A method, apparatus, and system for storing an execution plan, and relate to the field of databases, which may improve a cache hit rate of an execution plan and reduce system overheads. The method includes sending, by the client, a structured query language (SQL) request and generated location information to the database server, and according to the received SQL request and the received location information, generating and executing, by the database server, an execution plan corresponding to the SQL request, and saving the execution plan to a cache indicated by the location information. The location information may indicate a location of a cache of a client or a cache of a database server.

### CROSS-REFERENCE TO RELATED APPLICATIONS

This application is a continuation of International Application No. PCT/CN2014/075520, filed on Apr. 16, 2014, which claims priority to Chinese Patent Application No. 201310507367.8, filed on Oct. 24, 2013, all of which are hereby incorporated by reference in their entireties.

### TECHNICAL FIELD

The present disclosure relates to the field of databases, and in particular, to a method, apparatus, and system for storing an execution plan.

### BACKGROUND

An execution plan in a database refers to a description of an execution process of a structured query language (SQL) request. Each time a database server executes a SQL request initiated by a client, the database server needs to parse the SQL request to generate a corresponding execution plan, and save the execution plan to a memory of the database server. Currently, when the database server saves an execution plan, the database server separately configures caches for different clients to save execution plans corresponding to the different clients.

When an execution plan is saved in a current execution plan storage manner, the database server separately configures caches for different clients. A cache occupied by an execution plan with a low utilization rate is released when a cache allocated to a client is saturated, so that an execution plan with a high utilization rate of the client is cached in the allocated cache, that is, the execution plan with a low utilization rate cannot be saved to the cache. Therefore, when the client initiates the SQL request again, the database server needs to re-parse the SQL request and generate a corresponding execution plan, which causes a lower cache hit rate of the execution plan and increases system overheads.

### SUMMARY

Embodiments of the present disclosure provide a method, apparatus, and system for storing an execution plan, which can improve a cache hit rate of an execution plan and reduce system overheads.

According to a first aspect, an embodiment of the present disclosure provides a method for storing an execution plan, including: receiving, by a client, a structured query language SQL request, detecting, by the client, whether an execution plan corresponding to the SQL request exists in a cache of the client, generating, by the client, location information if no execution plan corresponding to the SQL request exists in the cache of the client, where the location information is used to indicate a cache location of the execution plan corresponding to the SQL request, and the cache location is the cache of the client and/or a cache of a database server, and sending, by the client, the location information and the SQL request to the database server such that the database server generates the execution plan corresponding to the SQL request and saves the execution plan to the cache indicated by the location information.

In a first implementation manner of the first aspect, the method further includes: sending, by the client, the execution plan to the database server if the execution plan corresponding to the SQL request exists in the cache of the client such that the database server executes the execution plan.

With reference to the first aspect or the first implementation manner of the first aspect, in a second implementation manner of the first aspect, the sending, by the client, the execution plan to the database server if the execution plan corresponding to the SQL request exists in the cache of the client such that the database server executes the execution plan further includes selecting, by the client if multiple execution plans corresponding to the SQL request exist in the cache of the client, any execution plan from the multiple execution plans and sending the selected execution plan to the database server.

With reference to the first aspect, the first implementation manner of the first aspect, or the second implementation manner of the first aspect, in a third implementation manner of the first aspect, before the sending, by the client, the execution plan to the database server, the method further includes displaying, by the client using a graphical interface, parameter information of the execution plan, adjusting, by the client according to a parameter information modification instruction, the parameter information of the execution plan, and saving an adjusted execution plan to the cache of the client, and the step of the sending, by the client, the execution plan to the database server include sending, by the client, the adjusted execution plan to the database server.

With reference to the first aspect, the first implementation manner of the first aspect, the second implementation manner of the first aspect, or the third implementation manner of the first aspect, in a fourth implementation manner of the first aspect, after the sending, by the client, the location information and the SQL request to the database server, the method further includes if the location information specifies that the cache location of the execution plan is the cache of the client, receiving, by the client, the execution plan sent by the database server and corresponding to the SQL request, and saving the execution plan to the cache of the client.

With reference to the first aspect, the first implementation manner of the first aspect, the second implementation manner of the first aspect, the third implementation manner of the first aspect, or the fourth implementation manner of the first aspect, in a fifth implementation manner of the first aspect, the generating, by the client, location information if no execution plan corresponding to the SQL request exists in the cache of the client further includes performing, by the client according to the SQL request, a Hash operation to generate the location information if no execution plan corresponding to the SQL request exists in the cache of the client.

According to a second aspect, an embodiment of the present disclosure provides an apparatus for storing an execution plan, including a receiving unit configured to receive a SQL request, a detection unit configured to detect whether an execution plan received by the receiving unit and corresponding to the SQL request exists in a cache of the client, a generation unit configured to generate location information when no execution plan detected by the detection unit and corresponding to the SQL request exists in the cache of the client, where the location information is used to indicate a cache location of the execution plan corresponding to the SQL request, and the cache location is the cache of the client and/or a cache of a database server, and a sending unit configured to send the location information and the SQL request to the database server.

In a first implementation manner of the second aspect, the sending unit is further configured to send the execution plan to the database server when the execution plan corresponding to the SQL request exists in the cache of the client such that the database server executes the execution plan.

With reference to the second aspect or the first implementation manner of the second aspect, in a second implementation manner of the second aspect, the sending unit is further configured to, when multiple execution plans corresponding to the SQL request exist in the cache of the client, select any execution plan from the multiple execution plans and send the selected execution plan to the database server.

With reference to the second aspect, the first implementation manner of the second aspect, or the second implementation manner of the second aspect, in a third implementation manner of the second aspect, the apparatus further includes a displaying unit configured to display, using a graphical interface, parameter information of the execution plan detected by the detection unit, an adjustment unit configured to adjust, according to a parameter information modification instruction, the parameter information of the execution plan and displayed by the displaying unit, and a saving unit configured to save an adjusted execution plan to the cache of the client, where the sending unit is further configured to send the execution plan adjusted by the adjustment unit to the database server.

With reference to the second aspect, the first implementation manner of the second aspect, the second implementation manner of the second aspect, or the third implementation manner of the second aspect, in a fourth implementation manner of the second aspect, the receiving unit is further configured to receive the execution plan sent by the database server and corresponding to the SQL request when the location information specifies that the cache location of the execution plan is the cache of the client, and the saving unit is further configured to save the execution plan received by the receiving unit to the cache of the client.

With reference to the second aspect, the first implementation manner of the second aspect, the second implementation manner of the second aspect, the third implementation manner of the second aspect, or the fourth implementation manner of the second aspect, in a fifth implementation manner of the second aspect, the generation unit is further configured to perform, according to the SQL request, a hash operation to generate the location information when no execution plan corresponding to the SQL request exists in the cache of the client.

According to a third aspect, an embodiment of the present disclosure provides a method for storing an execution plan, including receiving, by a database server, location information and a SQL request that are sent by a client, where the location information is used to indicate a cache location of the execution plan corresponding to the SQL request, and the cache location is a cache of the client and/or a cache of the database server, acquiring, by the database server, the execution plan corresponding to the SQL request, acquiring, by the database server according to the location information, the cache location of the execution plan, and sending, by the database server, the execution plan to the client to save the execution plan if the location information specifies that the cache location of the execution plan is the cache of the client.

In a first implementation manner of the third aspect, before the receiving, by a database server, location information and a SQL request that are sent by a client, the method further includes receiving, by the database server if the execution plan corresponding to the SQL request exists in the cache of the client, the execution plan sent by the client, and executing the execution plan.

With reference to the third aspect or the first implementation manner of the third aspect, in a second implementation manner of the third aspect, the receiving, by the database server if the execution plan corresponding to the SQL request exists in the cache of the client, the execution plan sent by the client, and executing the execution plan includes if multiple execution plans corresponding to the SQL request exist in the cache of the client, receiving, by the database server, any execution plan selected from the multiple execution plans and sent by the client, and executing the selected execution plan.

With reference to the third aspect, the first implementation manner of the third aspect, or the second implementation manner of the third aspect, in a third implementation manner of the third aspect, the receiving, by the database server if the execution plan corresponding to the SQL request exists in the cache of the client, the execution plan sent by the client, and executing the execution plan further includes, if the execution plan corresponding to the SQL request exists in the cache of the client, and the client performs a parameter adjustment on the execution plan using a graphical interface, receiving, by the database server, an adjusted execution plan sent by the client, and executing the execution plan.

With reference to the third aspect, the first implementation manner of the third aspect, the second implementation manner of the third aspect, or the third implementation manner of the third aspect, in a fourth implementation manner of the third aspect, after the acquiring, by the database server according to the location information, the cache location of the execution plan, the method further includes saving, by the database server, the execution plan to the cache of the database server if the location information specifies that the cache location of the execution plan is the cache of the database server.

According to a fourth aspect, an embodiment of the present disclosure provides an apparatus for storing an execution plan, including a receiving unit configured to receive location information and a SQL request that are sent by a client, where the location information is used to indicate a cache location of an execution plan corresponding to the SQL request, and the cache location is a cache of the client and/or a cache of a database server, an acquiring unit configured to acquire, according to the SQL request received by the receiving unit, the execution plan corresponding to the SQL request, where the acquiring unit is further configured to acquire the cache location of the execution plan according to the location information, and a sending unit configured to send the execution plan to the client to save the execution plan when the location information specifies that the cache location of the execution plan is the cache of the client.

In a first implementation manner of the fourth aspect, the receiving unit is further configured to, when the execution plan corresponding to the SQL request exists in the cache of the client, receive the execution plan sent by the client, and the apparatus further includes an execution unit configured to execute the execution plan received by the receiving unit.

With reference to the fourth aspect or the first implementation manner of the fourth aspect, in a second implementation manner of the fourth aspect, the receiving unit is further configured to, when multiple execution plans corresponding to the SQL request exist in the cache of the client, receive any execution plan selected from the multiple execution plans and sent by the client, and the execution unit is further configured to execute the any execution plan received by the receiving unit.

With reference to the fourth aspect, the first implementation manner of the fourth aspect, or the second implementation manner of the fourth aspect, in a third implementation manner of the fourth aspect, the receiving unit is further configured to, when the execution plan corresponding to the SQL request exists in the cache of the client, and the client performs a parameter adjustment on the execution plan using a graphical interface, receive an adjusted execution plan sent by the client, and the execution unit is further configured to execute the adjusted execution plan received by the receiving unit.

With reference to the fourth aspect, the first implementation manner of the fourth aspect, the second implementation manner of the fourth aspect, or the third implementation manner of the fourth aspect, in a fourth implementation manner of the fourth aspect, the apparatus further includes a saving unit configured to save the execution plan to the cache of the database server when the location information specifies that the cache location of the execution plan is the cache of the database server.

According to a fifth aspect, an embodiment of the present disclosure provides a system for storing an execution plan, including at least one client and at least one database server, where the client is configured to receive a SQL request, and detect whether an execution plan corresponding to the SQL request exists in a cache of the client, the client is further configured to, when no execution plan corresponding to the SQL request exists in the cache of the client, generate location information and send the location information and the SQL request to the database server, where the location information is used to indicate a cache location of the execution plan corresponding to the SQL request, and the cache location is the cache of the client and/or a cache of the database server, the database server is configured to receive the location information and the SQL request that are sent by the client, and acquire the execution plan corresponding to the SQL request according to the location information and the SQL request, and the database server is further configured to acquire the cache location of the execution plan according to the location information, and send the execution plan to the client to save the execution plan when the location information specifies that the cache location of the execution plan is the cache of the client.

Embodiments of the present disclosure provide a method, apparatus, and system for storing an execution plan. The client sends an SQL request and generated location information to the database server, and according to the received SQL request and the received location information, the database server generates and executes an execution plan corresponding to the SQL request, and saves the execution plan to a cache indicated by the location information. Compared with the prior art, in the embodiments of the present disclosure, an execution plan that has been executed by the client is saved to the cache of the client. This avoids that some execution plans cannot be saved to the cache, which improves a cache hit rate of an execution plan, and therefore reduces system overheads.

### BRIEF DESCRIPTION OF DRAWINGS

To describe the technical solutions in the embodiments of the present disclosure more clearly, the following briefly describes the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a flowchart of a method for storing an execution plan according to Embodiment 1 of the present disclosure;

FIG. 2 is a schematic structural diagram of an apparatus for storing an execution plan according to Embodiment 1 of the present disclosure;

FIG. 3 is a schematic structural diagram of a base station according to Embodiment 1 of the present disclosure;

FIG. 4 is a flowchart of a method for storing an execution plan according to Embodiment 2 of the present disclosure;

FIG. 5 is a schematic structural diagram of an apparatus for storing an execution plan according to Embodiment 2 of the present disclosure;

FIG. 6 is a schematic structural diagram of a base station according to Embodiment 2 of the present disclosure; and

FIG. 7 is a schematic diagram of a system for storing an execution plan according to Embodiment 3 of the present disclosure.

### DESCRIPTION OF EMBODIMENTS

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by a person of ordinary skill in the art based on the embodiments of the present disclosure without creative efforts shall fall within the protection scope of the present disclosure.

To make the advantages of the technical solutions of the present disclosure clearer, the following describes the present disclosure in detail with reference to the accompanying drawings and embodiments.

### Embodiment 1

This embodiment of the present disclosure provides a method for storing an execution plan, which may be applied to a system as shown in FIG. 7, where the system includes at least one client and at least one database server. The client may send an SQL request and generated location information to the database server, and may further receive an execution plan sent by the database server and corresponding to the SQL request, and save the execution plan to a cache of the client, and the database server may receive the SQL request and the location information that are sent by the client, and may further send a generated execution plan corresponding to the SQL request to the client, where the execution plan corresponding to the SQL request can be saved to both the cache of the client and a cache of the database server.

Based on the system, this embodiment of the present disclosure provides the method for storing an execution plan, as shown in FIG. 1, which may be applied to a client side, and the method includes the following steps:

Step 101. The client receives the SQL request.

The SQL request is a database query language that is used to access data in a database system and query, update, and manage the database system. A user may enter, using a disk operating system (DOS) command or a C++ language, an SQL statement that needs to be executed.

Step 102. The client detects whether the execution plan corresponding to the SQL request exists in the cache of the client.

The execution plan corresponding to the SQL request is a specific execution process corresponding to the SQL request in the database system. The foregoing cache of the client saves an executed execution plan specified to be saved. The execution plan specified to be saved may be further specified by a user, or may be preconfigured in the database server, which is not limited in this embodiment of the present disclosure.

Optionally, step 102 may further include searching execution plans one by one that are saved to the cache of the client, until the execution plan corresponding to the SQL request is found. Optionally, step 102 may further include firstly, establishing, by the client, a hash table, and saving, to the hash table, location information of a location, in the cache of the client, of each execution plan, then, searching the hash table for location information of a location, in the cache of the client, of the execution plan corresponding to the SQL request, and finally, searching the cache of the client for the execution plan corresponding to the SQL request using the location information. This improves efficiency of searching for the execution plan corresponding to the SQL request.

Step 103a. The client performs, according to the SQL request, a Hash operation to generate the location information if no execution plan corresponding to the SQL request exists in the cache of the client.

The location information is used to indicate a cache location of the execution plan corresponding to the SQL request, and the cache location is the cache of the client and/or the cache of the database server. In this embodiment of the present disclosure, the location information may be specified in a hint. In this case, when PlanCacheServer is specified in the hint, it is specified that the execution plan is saved to the database server. When PlanCacheClient is specified in the hint, it is specified that the execution plan is saved to the client. When PlanCacheAll is specified in the hint, it is specified that that the execution plan is saved to the database server and the client. If the client does not generate the location information, PlanCacheAll is used as the location information by default by the database server, that is, it is specified that the execution plan is saved to the database server and the client.

In this embodiment of the present disclosure, the client may perform, according to the SQL request, a hash operation or other operations to generate the location information, which is not limited in this embodiment of the present disclosure.

By using the location information corresponding to the SQL request, it may be implemented that the cache location of the execution plan is determined according to a requirement of a user, and it is implemented that an execution plan that has been executed by the client is saved to the client. This avoids a problem of a low cache hit rate of an execution plan caused by a failure in permanently saving some execution plans to the database server resulting from limited cache space of the database server.

After step 103a, step 104a is further included the client sends the location information and the SQL request to the database server.

Further, the database server generates the execution plan corresponding to the SQL request, and saves the execution plan after acquiring the cache location of the execution plan according to the location information.

The step of generating, by the database server, the execution plan corresponding to the SQL request may include parsing, by the database server, the SQL request sent by the client, and generating the execution plan corresponding to the SQL request. Because a process of parsing the SQL request and generating the execution plan by the database server is time-consuming, a cache hit rate of the execution plan can be improved by saving all executed execution plans to the cache of the client and/or the cache of the database server. This avoids that the database server re-parses an executed SQL request and generates a corresponding execution plan due to a failure in permanently saving all executed execution plans to the current database server, which reduces system overheads.

In this embodiment of the present disclosure, the cache location of the execution plan may be the cache of the database server or the cache of the client. Because a cache occupied by an execution plan that has been executed by the client is small, in this embodiment of the present disclosure, all or some execution plans that have been executed by the client are saved to the cache of the client, and a saturated cache of the client and a saturated cache of the database server do not occur, which improves a cache hit rate of an execution plan in comparison with that currently all execution plans that have been executed by the client are saved to the cache of the database server and some execution plans cannot be saved due to a saturated cache of the database server. Moreover, an execution plan saved in the cache of the client is still saved in the cache of the client after the client restarts. This avoids a case in which an execution plan saved in the database server is lost after the database server restarts.

In step 103b paralleled with step 103a, if the execution plan corresponding to the SQL request exists in the cache of the client, the client sends the execution plan to the database server.

Further, the database server executes the execution plan corresponding to the SQL request. In this embodiment of the present disclosure, when an executed execution plan has been saved to the cache of the client, the database server may directly execute the execution plan, and does not need to re-parse the SQL request corresponding to the execution plan to generate the execution plan, which improves efficiency of executing the SQL request.

If multiple execution plans corresponding to the SQL request exist in the cache of the client, the client selects any execution plan from the multiple execution plans and sends the execution plan to the database server.

Generally, one SQL request corresponds to one execution plan. However, some complex SQL requests may correspond to multiple different execution plans. If multiple execution plans corresponding to the SQL request are saved to the cache of the client, in this case, the client selects any execution plan from the multiple execution plans and sends the execution plan to the database server. Preferably, the client may select a commonly used execution plan or an execution plan with short execution duration from the multiple execution plans and send the selected execution plan to the database server.

Optionally, before step 103b, the method may further include displaying, by the client, parameter information of the execution plan using a graphical interface, and adjusting, by the client, the parameter information of the execution plan according to a parameter information modification instruction, and saving an adjusted execution plan to the cache of the client. At this time, the client sends the adjusted execution plan to the database server.

The graphical interface is a screen of the client, which uses a textbox and an arrow to display specific information about the execution plan and display each piece of parameter information corresponding to the execution plan such that a user performs parameter modification in a more intuitive and quick manner. In this embodiment of the present disclosure, if parameter information of an execution plan is not adjusted, a process of executing the execution plan by the database server is a default process in the system rather than an optimal process. Therefore, adjusting parameter information of an execution plan can increase a speed of executing the execution plan in the database server. An adjusted execution plan is saved to the cache of the client as an added execution plan corresponding to the SQL request, and does not replace an execution plan that is not adjusted.

After step 104a, step 105a is further included, if the location information specifies that the cache location of the execution plan is the cache of the client, the client receives the execution plan sent by the database server and corresponding to the SQL request and saves the execution plan to the cache of the client.

In this embodiment of the present disclosure, because an executed execution plan may be saved to the cache of the client, a user may implement sharing of the execution plan between different clients by performing operations, such as copy, import, and export, on the execution plan saved to the cache of the client. The client copies the execution plan in the cache and saves the execution plan in a form of a file. In this case, other clients may acquire the file of the execution plan and restore the execution plan in the cache of the current client, thereby implementing sharing of the execution plan between different clients.

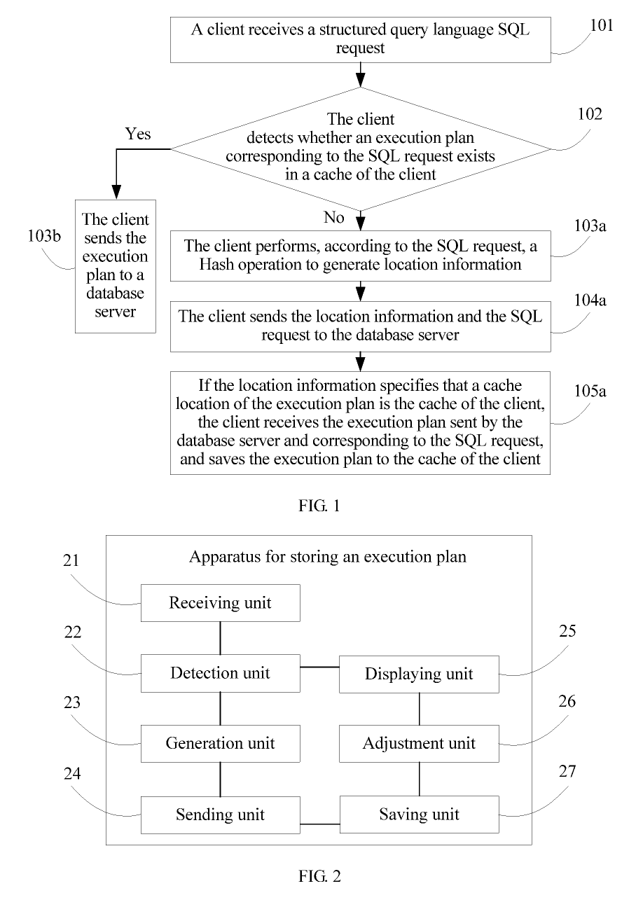

Further, as a specific implementation of the method shown in FIG. 1, this embodiment of the present disclosure provides an apparatus for storing an execution plan. As shown in FIG. 2, an entity of the apparatus may be a client, where the apparatus includes a receiving unit 21, a detection unit 22, a generation unit 23, and a sending unit 24.

The receiving unit 21 is configured to receive a SQL request.

The detection unit 22 is configured to detect whether an execution plan received by the receiving unit 21 and corresponding to the SQL request exists in a cache of the client.

The generation unit 23 is configured to generate location information when no execution plan detected by the detection unit 22 and corresponding to the SQL request exists in the cache of the client, where the location information is used to indicate a cache location of the execution plan corresponding to the SQL request, and the cache location is the cache of the client and/or a cache of a database server.

The sending unit 24 is configured to send the location information and the SQL request to the database server.

The sending unit 24 is further configured to send the execution plan to the database server when the execution plan corresponding to the SQL request exists in the cache of the client.

The sending unit 24 is further configured to, when multiple execution plans corresponding to the SQL request exist in the cache of the client, select any execution plan from the multiple execution plans and send the selected execution plan to the database server.

Optionally, the apparatus may further include a displaying unit 25, an adjustment unit 26, and a saving unit 27.

The displaying unit 25 is configured to display, using a graphical interface, parameter information of the execution plan detected by the detection unit 22.

The adjustment unit 26 is configured to adjust, according to a parameter information modification instruction, the parameter information of the execution plan and displayed by the displaying unit 25.

The saving unit 27 is configured to save an adjusted execution plan to the cache of the client.

The sending unit 24 is further configured to send the execution plan adjusted by the adjustment unit 26 to the database server.

The receiving unit 21 is further configured to receive the execution plan sent by the database server and corresponding to the SQL request when the location information specifies that the cache location of the execution plan is the cache of the client.

The saving unit 27 is further configured to save the execution plan received by the receiving unit 21 to the cache of the client.

The generation unit 23 is further configured to perform, according to the SQL request, a Hash operation to generate the location information when no execution plan corresponding to the SQL request exists in the cache of the client.

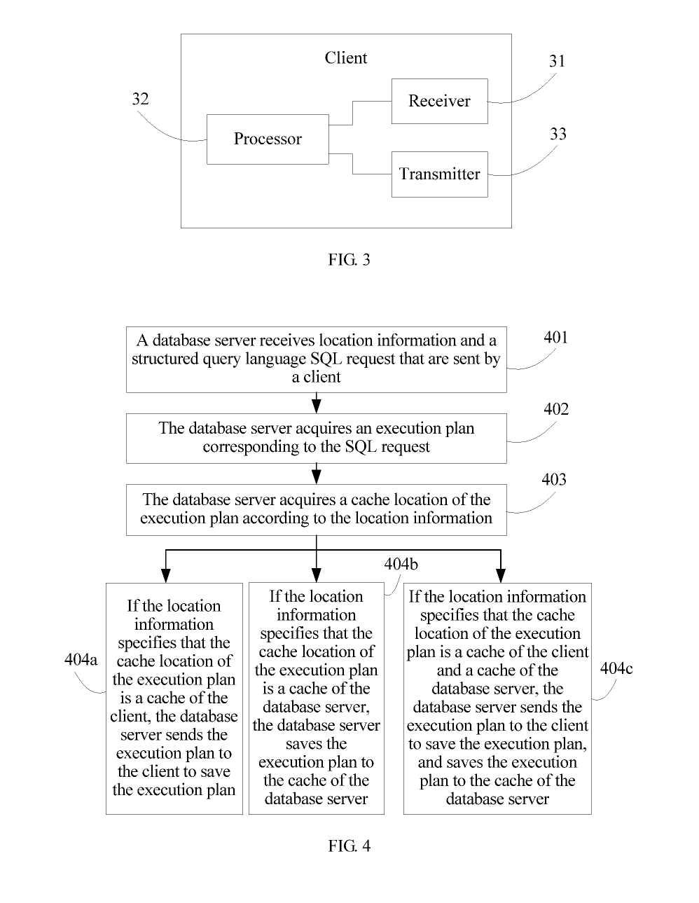

Still further, the entity of the apparatus for storing an execution plan may be a client. As shown in FIG. 3, the client may include a receiver 31, a processor 32, and a transmitter 33.

The receiver 31 is configured to receive a SQL request.

The processor 32 is configured to detect whether an execution plan corresponding to the SQL request exists in a cache of the client.

The processor 32 is further configured to generate location information when no execution plan corresponding to the SQL request exists in the cache of the client, where the location information is used to indicate a cache location of the execution plan corresponding to the SQL request, and the cache location is the cache of the client and/or a cache of a database server.

The transmitter 33 is configured to send the location information and the SQL request to the database server.

The transmitter 33 is further configured to send the execution plan to the database server when the execution plan corresponding to the SQL request exists in the cache of the client.

The transmitter 33 is further configured to, when multiple execution plans corresponding to the SQL request exist in the cache of the client, select any execution plan from the multiple execution plans and send the selected execution plan to the database server.

The processor 32 is further configured to display parameter information of the execution plan using a graphical interface.

The processor 32 is further configured to adjust the parameter information of the execution plan according to a parameter information modification instruction.

The processor 32 is further configured to save an adjusted execution plan to the cache of the client.

The transmitter 33 is further configured to send the execution plan to the database server.

The receiver 31 is configured to receive the execution plan sent by the database server and corresponding to the SQL request when the location information specifies that the cache location of the execution plan is the cache of the client.

The processor 32 is further configured to save the execution plan to the cache of the client.

The processor 32 is further configured to perform, according to the SQL request, a Hash operation to generate the location information when no execution plan corresponding to the SQL request exists in the cache of the client.

It should be noted that, for other corresponding descriptions of each function unit in the apparatus for storing an execution plan provided in this embodiment of the present disclosure, refer to corresponding descriptions of FIG. 1, and details are not repeatedly described herein.

According to the method and apparatus for storing an execution plan provided in this embodiment of the present disclosure, a client sends an SQL request and generated location information to a database server, and according to the received SQL request and the received location information, the database server generates and executes an execution plan corresponding to the SQL request, and saves the execution plan to a cache indicated by the location information. Compared with the prior art, in this embodiment of the present disclosure, an execution plan that has been executed by the client is saved to the cache of the client. This avoids that some execution plans cannot be saved to the cache, which improves a cache hit rate of an execution plan, and therefore reduces system overheads.

### Embodiment 2

This embodiment of the present disclosure provides a method for storing an execution plan, which may be applied to a system as shown in FIG. 7, where the system includes at least one client and at least one database server. The client may send an SQL request and generated location information to the database server, and may further receive an execution plan sent by the database server and corresponding to the SQL request, and save the execution plan to a cache of the client, and the database server may receive the SQL request and the location information that are sent by the client, and may further send a generated execution plan corresponding to the SQL request to the client, where the execution plan corresponding to the SQL request can be saved to both the cache of the client and a cache of the database server.

Based on the system, this embodiment of the present disclosure provides the method for storing an execution plan, as shown in FIG. 4, which may be applied to a database server side, and the method includes the following steps:

Step 401. The database server receives the location information and the SQL request that are sent by the client.

Optionally, before step 401, the method may further include receiving, by the database server if the execution plan corresponding to the SQL request sent by the client exists in the cache of the client, the execution plan sent by the client, and then directly executing the execution plan. The database server does not need to re-parse the SQL request corresponding to the execution plan to generate the execution plan, which improves efficiency of executing the SQL request.

If multiple execution plans corresponding to the SQL request exist in the cache of the client, the database server receives any execution plan selected from the multiple execution plans and sent by the client, and executes the selected execution plan.

Generally, one SQL request corresponds to one execution plan. However, some complex SQL requests may correspond to multiple different execution plans. If multiple execution plans corresponding to the SQL request are saved to the cache of the client, in this case, the client selects any execution plan from the multiple execution plans and sends the selected execution plan to the database server. Preferably, the database server receives a commonly used execution plan or an execution plan with a short execution duration, where the commonly used execution plan or the execution plan with short execution duration is selected from the multiple execution plans and sent by the client.

Alternatively, if the execution plan corresponding to the SQL request exists in the cache of the client, and the client performs a parameter adjustment on the execution plan using a graphical interface, the database server receives an adjusted execution plan sent by the client, and executes the execution plan.

The graphical interface is a screen of the client, which uses a textbox and an arrow to display specific information about the execution plan and display each piece of parameter information corresponding to the execution plan such that a user performs parameter modification more intuitively and quickly. In this embodiment of the present disclosure, if parameter information of an execution plan is not adjusted, a process of executing the execution plan by the database server is a default process in the system rather than an optimal process. Therefore, adjusting parameter information of an execution plan can increase a speed of executing the execution plan in the database server. An adjusted execution plan is saved to the cache of the client as an added execution plan corresponding to the SQL request, and does not replace an execution plan that is not adjusted.

The database server in this embodiment of the present disclosure may be a database server, where the database server may provide a user with services such as query, update, and management.

Step 402. The database server acquires the execution plan corresponding to the SQL request.

In this embodiment, at step 402, the database server may further search the cache to detect whether the execution plan corresponding to the SQL request exists in the cache, where if the execution plan corresponding to the SQL request exists in the cache of the database server, the database server directly acquires the execution plan such that the database server executes the execution plan corresponding to the SQL request, or if no execution plan corresponding to the SQL request exists in the cache of the database server, the database server parses the SQL request and generates the execution plan corresponding to the SQL request such that the database server executes the execution plan corresponding to the SQL request.

Step 403. The database server acquires the cache location of the execution plan according to the location information.

The location information is used to indicate a cache location of the execution plan corresponding to the SQL request, and the cache location is the cache of the client and/or the cache of the database server. In this embodiment of the present disclosure, the location information may be specified in a hint. In this case, when PlanCacheServer is specified in the hint, it is specified that the execution plan is saved to the cache of the database server. When PlanCacheClient is specified in the Hint, it is specified that the execution plan is saved to the cache of the client. When PlanCacheAll is specified in the hint, it is specified that the execution plan is saved to the cache of the database server and the cache of the client. If the client does not generate the location information that needs to be carried in the SQL request, PlanCacheAll is used as the location information by default by the database server, that is, it is specified that the execution plan is saved to the cache of the database server and the cache of the client.

In this embodiment of the present disclosure, the client may perform, according to the SQL request, a Hash operation or other operations to generate the location information, which is not limited in this embodiment of the present disclosure.

By using the location information corresponding to the SQL request, it may be implemented that the cache location of the execution plan is determined according to a requirement of a user, and it is implemented that an execution plan that has been executed by the client is saved to the client. This avoids a problem of a low cache hit rate of an execution plan caused by a failure in permanently saving some execution plans to the database server resulting from limited cache space of the database server.

Step 404a. If the location information specifies that the cache location of the execution plan is the cache of the client, the database server sends the execution plan to the client to save the execution plan.

In this embodiment of the present disclosure, because the cache of the client is sufficient to store all execution plans of the client, and a loss of the execution plans saved to the cache of the client will not be caused by a client restart, the database server can ensure, by sending the execution plans to the client to save the execution plans, that all execution plans are saved permanently in the cache of the client. Moreover, because all execution plans of the client can be saved permanently in the cache of the client, when receiving the SQL request again, the database server does not need to re-parse the SQL request to generate the execution plan corresponding to the SQL request, which reduces system overheads.

In step 404b paralleled with step 404aI, if the location information specifies that the cache location of the execution plan is the cache of the database server, the database server saves the execution plan to the cache of the database server.

In step 404c paralleled with step 404a and step 404b, if the location information specifies that the cache location of the execution plan is the cache of the client and the cache of the database server, the database server sends the execution plan to the client to save the execution plan, and saves the execution plan to the cache of the database server.

According to this embodiment of the present disclosure, an execution plan corresponding to an SQL request of a client is saved to both a cache of the client and a cache of a database server, which improves a cache hit rate of the execution plan corresponding to the SQL request, moreover, by saving the execution plan corresponding to the SQL request to the cache of the database server, when another client sends the SQL request to the database server, the database server can directly find the execution plan corresponding to the SQL request and execute the execution plan, which improves efficiency of executing an execution plan.

Further, as a specific implementation of the method shown in FIG. 4, this embodiment of the present disclosure provides an apparatus for storing an execution plan. As shown in FIG. 5, an entity of the apparatus may be a database server, where the apparatus includes a receiving unit 51, an acquiring unit 52, and a sending unit 53.

The receiving unit 51 is configured to receive location information and a SQL request that are sent by a client, where the location information is used to indicate a cache location of an execution plan corresponding to the SQL request, and the cache location is a cache of the client and/or a cache of the database server.

The acquiring unit 52 is configured to acquire, according to the SQL request received by the receiving unit 51, the execution plan corresponding to the SQL request.

The acquiring unit 52 is further configured to acquire the cache location of the execution plan according to the location information.

The sending unit 53 is configured to send the execution plan to the client to save the execution plan when the location information specifies that the cache location of the execution plan is the cache of the client.

The receiving unit 51 is further configured to, when the execution plan corresponding to the SQL request exists in the cache of the client, receive the execution plan sent by the client.

Optionally, the apparatus may further include an execution unit 54.

The execution unit 54 is configured to execute the execution plan received by the receiving unit 51.

The receiving unit 51 is further configured to, when multiple execution plans corresponding to the SQL request exist in the cache of the client, receive any execution plan selected from the multiple execution plans and sent by the client.

The execution unit 54 is further configured to execute the any execution plan received by the receiving unit 51.

The receiving unit 51 is further configured to, when the execution plan corresponding to the SQL request exists in the cache of the client, and the client performs a parameter adjustment on the execution plan using a graphical interface, receive an adjusted execution plan sent by the client.

The execution unit 54 is further configured to execute the adjusted execution plan received by the receiving unit 51.

Optionally, the apparatus may further include a saving unit 55.

The saving unit 55 is configured to save the execution plan to the cache of the database server when the location information specifies that the cache location of the execution plan is the cache of the database server.

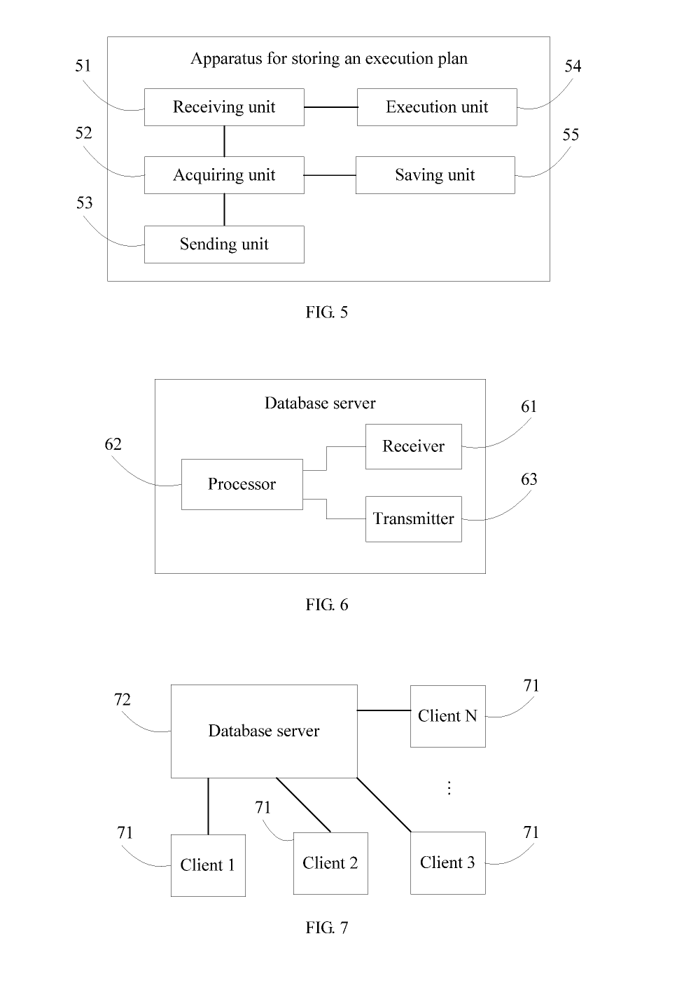

Still further, the entity of the apparatus for storing an execution plan may be a database server. As shown in FIG. 6, the database server may include a receiver 61, a processor 62, and a transmitter 63.

The receiver 61 is configured to receive location information and a SQL request that are sent by a client, where the location information is used to indicate a cache location of an execution plan corresponding to the SQL request, and the cache location is a cache of the client and/or a cache of the database server.

The processor 62 is configured to acquire, according to the SQL request, the execution plan corresponding to the SQL request.

The processor 62 is further configured to acquire the cache location of the execution plan according to the location information.

The transmitter 63 is configured to send the execution plan to the client to save the execution plan when the location information specifies that the cache location of the execution plan is the cache of the client.

The receiver 61 is further configured to, when the execution plan corresponding to the SQL request exists in the cache of the client, receive the execution plan sent by the client.

The processor 62 is further configured to execute the execution plan.

The receiver 61 is further configured to, when multiple execution plans corresponding to the SQL request exist in the cache of the client, receive any execution plan selected from the multiple execution plans and sent by the client.

The processor 62 is further configured to execute the any execution plan.

The receiver 61 is further configured to, when the execution plan corresponding to the SQL request exists in the cache of the client, and the client performs a parameter adjustment on the execution plan using a graphical interface, receive an adjusted execution plan sent by the client.

The processor 62 is further configured to execute the adjusted execution plan.

The processor 62 is further configured to save the execution plan to the cache of the database server when the location information specifies that the cache location of the execution plan is the cache of the database server.

It should be noted that, for other corresponding descriptions of each function unit in the apparatus for storing an execution plan provided in this embodiment of the present disclosure, reference may be made to corresponding descriptions of FIG. 4, and details are not repeatedly described herein.

According to the method and apparatus for storing an execution plan provided in this embodiment of the present disclosure, a client sends an SQL request and generated location information to a database server, and according to the received SQL request and the received location information, the database server generates and executes an execution plan corresponding to the SQL request, and saves the execution plan to a cache indicated by the location information. Compared with the prior art, in this embodiment of the present disclosure, an execution plan that has been executed by the client is saved to the cache of the client. This avoids that some execution plans cannot be saved to the cache, which improves a cache hit rate of an execution plan, and therefore reduces system overheads.

### Embodiment 3

This embodiment of the present disclosure provides a system for storing an execution plan. As shown in FIG. 7, the system includes at least one client 71 and at least one database server 72.

The client 71 is configured to first acquire a SQL request, and then detect whether an execution plan corresponding to the SQL request exists in a cache, and when no execution plan corresponding to the SQL request exists in the cache, generate location information and send the location information and the SQL request to the database server 72.

The database server 72 is configured to first receive the location information and the SQL request that are sent by the client 71, and then acquire the execution plan corresponding to the SQL request according to the SQL request, and acquire a cache location of the execution plan according to the location information, and send the execution plan to the client 71 to save the execution plan when the location information specifies that the cache location of the execution plan is the cache of the client 71.

According to the system for storing an execution plan provided in this embodiment of the present disclosure, a client sends an SQL request and generated location information to a database server, and according to the received SQL request and the received location information, the database server generates and executes an execution plan corresponding to the SQL request, and saves the execution plan to a cache indicated by the location information. Compared with that currently a database server configures caches in the database server separately for different clients when saving an execution plan so as to save execution plans corresponding to different clients, in this embodiment of the present disclosure, an execution plan that has been executed by the client is saved to the cache of the client. This avoids that some execution plans cannot be saved to the cache, which improves a cache hit rate of an execution plan, and therefore reduces system overheads.

The method, apparatus, and system provided in the embodiments of the present disclosure may further be used to resolve some problems existing in a stand-alone database, a dual-node database, and a cluster database.

For example, in a stand-alone database scenario, a cache of a stand-alone database server is insufficient to store all execution plans corresponding to all clients. With the method provided in the embodiments of the present disclosure, the execution plans that need to be saved to the cache of the stand-alone database server may be saved to caches of all the clients corresponding to the stand-alone database server, which reduces cache space occupied by the execution plans in the cache of the stand-alone database server.

In a dual-node database scenario, because a dual-node database server randomly saves execution plans to one database of two databases, when a client initiates an SQL request, the dual-node database server needs to search all execution plans in the two databases. Therefore, in the dual-node database scenario, complexity of searching for an execution plan corresponding to the SQL request is high. With the method provided in the embodiments of the present disclosure, an executed execution plan corresponding to an SQL request may be saved to a cache of a client, when the client initiates an SQL request, an execution plan corresponding to the request may be directly acquired from the cache of the client. This avoids the dual-node database server from searching all execution plans in the two databases, which further reduces searching complexity of the dual-node database server.

Similarly, in a cluster database scenario, because a cluster database server randomly saves execution plans to one database of multiple databases, when a client initiates an SQL request, the cluster database server needs to search all execution plans in all databases. Therefore, in the cluster database scenario, complexity of searching for an execution plan corresponding to the SQL request is high. With the method provided in the embodiments of the present disclosure, an executed execution plan corresponding to an SQL request may be saved to a cache of a client, when the client initiates an SQL request, an execution plan corresponding to the request may be directly acquired from the cache of the client. This avoids the cluster database server from searching all execution plans in all databases, which further reduces searching complexity of the cluster database server.

The apparatus for storing an execution plan provided in embodiments of the present disclosure can implement the foregoing provided method embodiments. For detailed function implementation, reference may be made to descriptions in the method embodiments, and details are not described herein again. The method, apparatus, and system for storing an execution plan provided in the embodiments of the present disclosure may be applicable to improving a cache hit rate of an execution plan and reducing system overheads, but is not limited thereto.

A person of ordinary skill in the art may understand that all or some of the processes of the methods in the embodiments may be implemented by a computer program instructing relevant hardware. The program may be stored in a computer readable storage medium. When the program runs, the processes of the methods in the embodiments are performed. The foregoing storage medium may include a magnetic disk, an optical disc, a read-only memory (ROM), or a random-access memory (RAM).

The foregoing descriptions are merely specific embodiments of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A method comprising:
receiving, by a client, a structured query language (SQL) request;
detecting, by the client, whether an execution plan corresponding to the SQL request is stored in a first cache of the client;
generating, by the client, location information when no execution plan corresponding to the SQL request is stored in the first cache of the client, wherein the location information indicates a cache location of the execution plan corresponding to the SQL request, and wherein the cache location is the first cache of the client and/or a second cache of a database server; and
sending, by the client, the location information and the SQL request to the database server such that the database server generates the execution plan corresponding to the SQL request and saves the execution plan according to the location information.

2. The method according to claim 1, further comprising sending, by the client, the execution plan to the database server when the execution plan corresponding to the SQL request is stored in the first cache of the client such that the database server executes the execution plan.

3. The method according to claim 2, wherein sending, by the client, the execution plan to the database server when the execution plan corresponding to the SQL request is stored in the first cache of the client such that the database server executes the execution plan comprises:
selecting, by the client when multiple execution plans corresponding to the SQL request are stored in the first cache of the client, any execution plan from the multiple execution plans; and
sending the selected execution plan to the database server.

4. The method according to claim 2, wherein before sending, by the client, the execution plan to the database server, the method further comprises:
displaying, by the client using a graphical interface, parameter information of the execution plan;
adjusting, by the client according to a parameter information modification instruction, the parameter information of the execution plan to produce an adjusted execution plan;
saving the adjusted execution plan to the first cache of the client; and
wherein sending, by the client, the execution plan to the database server comprises sending, by the client, the adjusted execution plan to the database server.

5. The method according to claim 1, wherein after sending, by the client, the location information and the SQL request to the database server, the method further comprises:
receiving, by the client, the execution plan sent by the database server and corresponding to the SQL request when the location information specifies that the cache location of the execution plan is the first cache of the client; and
saving the execution plan to the first cache of the client when the location information specifies that the cache location of the execution plan is the first cache of the client.

6. The method according to claim 1, wherein generating, by the client, the location information when no execution plan corresponding to the SQL request is stored in the first cache of the client comprises performing, by the client according to the SQL request, a hash operation to generate the location information when no execution plan corresponding to the SQL request exists in the cache of the client.

7. A method comprising:
receiving, by a database server, location information and a structured query language (SQL) request from a client, wherein the location information indicates a cache location of an execution plan corresponding to the SQL request, and the cache location is a first cache of the client and/or a second cache of the database server;
acquiring, by the database server, the execution plan corresponding to the SQL request;
acquiring, by the database server according to the location information, the cache location of the execution plan; and
sending, by the database server, the execution plan to the client to enable the client to save the execution plan when the location information specifies that the cache location of the execution plan is the first cache of the client.

8. The method according to claim 7, wherein before receiving, by the database server, the location information and the SQL request from the client, the method further comprises:
receiving, by the database server when the execution plan corresponding to the SQL request is stored in the first cache of the client, the execution plan from by the client; and
executing the received execution plan.

9. The method according to claim 7, wherein after acquiring, by the database server according to the location information, the cache location of the execution plan, the method further comprises saving, by the database server, the execution plan to the first cache of the database server when the location information specifies that the cache location of the execution plan is the second cache of the database server.

10. A client, comprising:
a first cache;
a receiver configured to receive a structured query language (SQL) request;
a processor coupled to the receiver and configured to:
detect whether an execution plan corresponding to the SQL request is stored in the first cache of the client; and
generate location information when no execution plan corresponding to the SQL request is stored in the first cache of the client, wherein the location information indicates a cache location of the execution plan corresponding to the SQL request, and wherein the cache location is the first cache of the client and/or a second cache of a database server; and
a transmitter coupled to the receiver and configured to send the location information and the SQL request to the database server.

11. The client according to claim 10, wherein the transmitter is further configured to send the execution plan to the database server when the execution plan corresponding to the SQL request is stored the first cache of the client.

12. The client according to claim 11, wherein the processor is further configured to, when multiple execution plans corresponding to the SQL request are stored in the first cache of the client, select any execution plan from the multiple execution plans, and wherein the transmitter is further configured to send the selected execution plan to the database server.

13. The client according to claim 11, wherein the receiver is further configured to receive the execution plan from the database server and corresponding to the SQL request when the location information specifies that the cache location of the execution plan is the first cache of the client, and wherein the processor is further configured to save the execution plan received by the receiver to the first cache of the client.

14. The client according to claim 10, further comprising a graphical interface display configured to display parameter information of the execution plan detected by the processor, wherein the processor is further configured to:
adjust, according to a parameter information modification instruction, the parameter information of the execution plan displayed by the graphical interface display to produce an adjusted execution plan; and
save the adjusted execution plan to the first cache of the client, and
wherein the transmitter is further configured to send the adjusted execution plan to the database server.

15. The client according to claim 10, wherein the processor is further configured to perform, according to the SQL request, a hash operation to generate the location information when no execution plan corresponding to the SQL request is stored in the first cache of the client.

16. A database server, comprising:
a receiver configured to:
receive location information from a client; and
receive a structured query language (SQL) request from the client, wherein the location information indicates a cache location of an execution plan corresponding to the SQL request, and wherein the cache location is a first cache of the client and/or a second cache of the database server;
a processor coupled to the receiver and configured to:
acquire, according to the SQL request received by the receiver, the execution plan corresponding to the SQL request; and
acquire the cache location of the execution plan according to the location information; and
a transmitter coupled to the processor and configured to send the execution plan to the client to enable the client to save the execution plan when the location information specifies that the cache location of the execution plan is the first cache of the client.

17. The database server according to claim 16, wherein the receiver is further configured to receive the execution plan from the client when the execution plan corresponding to the SQL request is stored in the first cache of the client, and wherein the processor is further configured to execute the execution plan received by the receiver.

18. The database server according to claim 17, wherein the receiver is further configured to receive an adjusted execution plan from the client when the execution plan corresponding to the SQL request is stored in the first cache of the client, wherein the adjusted execution plan comprises adjusted parameter information of the execution plan, and wherein the processor is further configured to execute the adjusted execution plan received by the receiver.

19. The database server according to claim 16, wherein the processor is further configured to save the execution plan to the second cache of the database server when the location information specifies that the cache location of the execution plan is the second cache of the database server.
